(19) United States
(12) Patent Application Publication
(10) Pub. No.: US 2013/0163453 A1
(43) Pub. Date: Jun. 27, 2013

(54) PRESENCE SENSOR WITH ULTRASOUND AND RADIO

(71) Applicants: Xintian E. Lin, Mountain View, CA (US); Qinghua Li, San Ramon, CA (US); Yongfa Zhou, Beijing (CN); Songnan Yang, San Jose, CA (US); Xianchao Xu, Beijing (CN)

(72) Inventors: Xintian E. Lin, Mountain View, CA (US); Qinghua Li, San Ramon, CA (US); Yongfa Zhou, Beijing (CN); Songnan Yang, San Jose, CA (US); Xianchao Xu, Beijing (CN)

(21) Appl. No.: 13/338,041

(22) Filed: Dec. 27, 2011

(51) Int. Cl. H04L 12/26

(52) U.S. Cl. 370/252

(57) ABSTRACT

An ultrasound and radio frequency technology is used to implement presence sensor capability for wireless devices such as, a laptap device. For example, the laptap device connects to a station device through a WiFi signal. In this example, the WiFi signal may include a data packet that synchronizes internal clocks of the laptap device with the station device. Further, the data packet may include transmitting time information for an ultrasound audio signal generated by the station device. The ultrasound audio signal is received by the laptap device that calculates time of flight (TOF) of the ultrasound audio signal. The TOF may be used to determine actual distance of the wireless device (e.g., laptap device) to the station device.

### BACKGROUND

Distance measurements between wireless devices (e.g., between a laptap device and a server device) may typically include use of received signal strength indication (RSSI) of sound or radio, time of flight (TOF) of high frequency radio signals, or TOF of sound. For the RSSI of sound or radio, distance measurement suffers from poor accuracy due to unknown antenna gain calibration. In other words, a typical error of 1-2 meters may be obtained. For the TOF of high frequency radio signals, a high resolution receiver may be required to achieve sub-meter accuracy in measuring the distance. The high resolution receiver may be required due to large wavelengths in high frequency signals. For the TOF of sound, the distance measurement suffers from difficulty of synchronizing the wireless devices.

Accordingly, a hardware solution may be implemented between the wireless devices to provide more accurate distance measurement.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a diagram illustrating an example system implementing presence sensor using ultrasound audio signal.

FIG. 2 is a diagram illustrating an example wireless device that implements presence sensor using ultrasound audio signal.

FIG. 3 is a diagram illustrating an example transmission and reception of ultrasound audio signal to implement presence sensor that uses the ultrasound audio signal.

FIG. 4 is a flow chart illustrating an example method for presence sensor using ultrasound audio signal.

### DETAILED DESCRIPTION

### Overview

An ultrasound and radio frequency technology is used to implement presence sensor capability for wireless devices such as, a laptap device. For example, the laptap device connects to a station device through a WiFi signal. In this example, the WiFi signal may include a data packet that includes a synchronization signal to synchronize internal clocks of the laptap device with the station device. Further, the data packet may include transmitting time information for an ultrasound audio signal generated by a speaker component of the station device. The ultrasound audio signal is received by the laptap device that calculates time of flight (TOF) of the ultrasound audio signal. The TOF may be used to determine actual distance of the wireless device (e.g., laptap device) to the station device by multiplying the TOF with speed of light. In other implementations, multiple station devices may be used to determine bearing location and distance of the wireless device to the station device.

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more than one. The term plurality, as used herein, is defined as two, or more than two. The term another, as used herein, is defined as, at least a second or more. The terms including and/or having, as used herein, are defined as, but not limited to, comprising. The term coupled as used herein, is defined as operably connected in any desired form for example, mechanically, electronically, digitally, directly, by software, by hardware and the like.

Some embodiments may be used in conjunction with various devices and systems, for example, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a display, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless AP, a wired or wireless router, a wired or wireless modem, a wired or wireless network, a wireless area network, a Wireless Video Are Network (WVAN), a Local Area Network (LAN), a WLAN, a PAN, a WPAN, devices and/or networks operating in accordance with existing WirelessHD™ and/or Wireless-Gigabit-Alliance (WGA) specifications and/or future versions and/or derivatives thereof, devices and/or networks operating in accordance with existing Institute of Electrical and Electronics Engineers or IEEE 802.11 (IEEE 802.11-2007: Wireless LAN Medium Access Control (MAC) and Physical Layer (PHY) Specifications) standards and amendments, 802.11ad (“the IEEE 802.11 standards”), IEEE 802.16 standards, and/or future versions and/or derivatives thereof, units and/or devices which are part of the above networks, one way and/or two-way radio communication systems, cellular radio-telephone communication systems, Wireless-Display (WiDi) device, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, a Wireless Application Protocol (WAP) device, or the like.

Some embodiments may be used in conjunction with one or more types of wireless communication signals and/or systems, for example, Radio Frequency (RF), Wi-Fi, Wi-Max, Ultra-Wideband (UWB), or the like. Other embodiments may be used in various other devices, systems and/or networks.

Some embodiments may be used in conjunction with suitable limited-range or short-range wireless communication networks, for example, “piconets”, e.g., a wireless area network, a WVAN, a WPAN, and the like.

### Example System

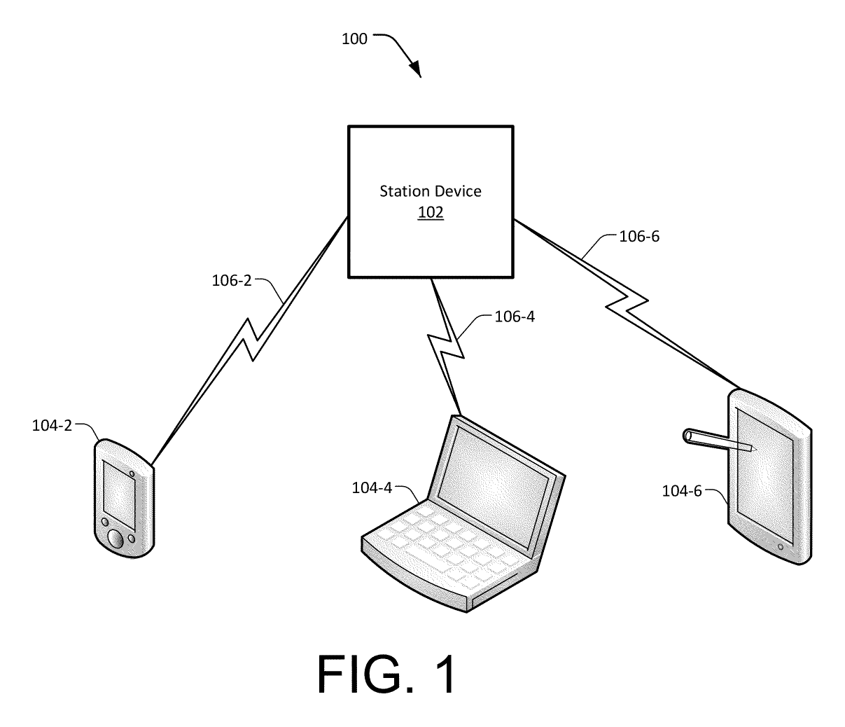

FIG. 1 shows a system-level overview of an example system environment 100 for implementing presence sensor using ultrasound audio signal. In an implementation, the system environment 100 may include a station device 102. For example, the station device 102 may include an access point (AP) device, a server device, or other devices that may transmit and receive radio frequencies when communicating with wireless enabled devices such as, wireless devices 104. In this example, the station device 102 may establish wireless connection with wireless devices 104 through a WiFi signal that is wirelessly communicated through signal 106. In an implementation, the WiFi signal from the station device 102 may be transmitted using the standard IEEE 802.11 frequency band, such as 5 GHz for IEEE 802.11a standard.

In an implementation, the WiFi signal may include a data packet that contains synchronization signal to synchronize internal clocks of the wireless devices 104 with the station device 102. Further, the data packet may include transmitting time information for an ultrasound audio signal (e.g., 20 KHz audio signal) generated by the station device 102. For example, the transmitting time information may include the station device 102 to generate the ultrasound audio signal after every one millisecond (i.e., 1 KHz frequency). In this example, the transmitting time information may be implemented after synchronization of the internal clocks in the wireless devices 104 and the station device 102. The synchronization may be used to accurately measure arrival time of the ultrasound audio signal at the wireless devices 104. In an implementation, the wireless devices 104 may receive the ultrasound signal at a particular instance or time. The actual time for receiving the ultrasound audio signal (hereinafter referred to as receiving time) may be used by the wireless devices 104 to calculate time of flight (TOF) of the ultrasound audio signal. The TOF may include difference between the receiving time and transmitting time of the ultrasound audio signal.

### Example Wireless Device

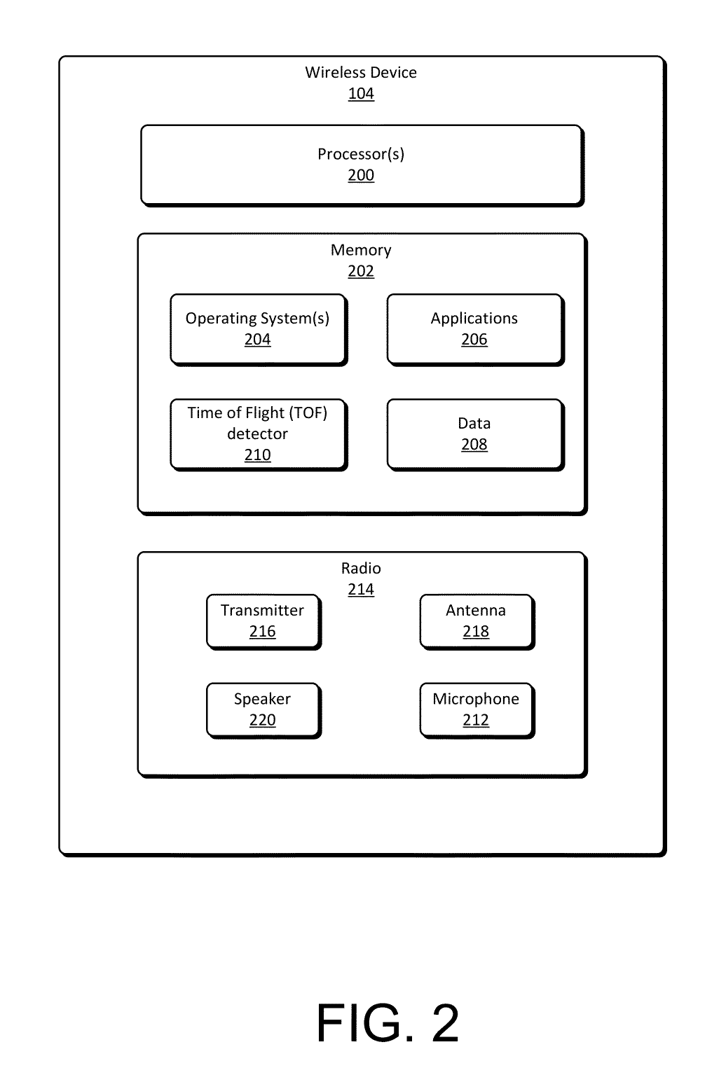

FIG. 2 is an example wireless device 104 that implements presence sensor using ultrasound audio signal. Wireless device 104 includes one or more processors, processor(s) 200. Processor(s) 200 may be a single processing unit or a number of processing units, all of which may include single or multiple computing units or multiple cores. The processor(s) 200 may be implemented as one or more microprocessors, microcomputers, microcontrollers, digital signal processors, central processing units, state machines, logic circuitries, and/or any devices that manipulate signals based on operational instructions. Among other capabilities, the processor(s) 200 may be configured to fetch and execute computer-readable instructions or processor-accessible instructions stored in a memory 202 or other computer-readable storage media.

Memory 202 is an example of computer-readable storage media for storing instructions which are executed by the processor(s) 200 to perform the various functions described herein. For example, memory 202 may generally include both volatile memory and non-volatile memory (e.g., RAM, ROM, or the like). Memory 202 may be referred to as memory or computer-readable storage media herein. Memory 202 is capable of storing computer-readable, processor-executable program instructions as computer program code that may be executed by the processor(s) 200 as a particular machine configured for carrying out the operations and functions described in the implementations herein.

Memory 202 may include one or more operating systems 204, and may store one or more applications 206. The operating system(s) 204 may be one of various known and future operating systems implemented for personal computers, audio video devices, etc. The applications 206 may include preconfigured/installed and downloadable applications. In addition, memory 202 may include data 208 to store the installed and downloaded applications. In an implementation, the data 208 may store the transmitting time information of the ultrasound audio signal that may be generated by another wireless device such as, the station device 102. In this implementation, the transmitting time information may be included in the data packet of the WiFi signal when wireless communication is established between the wireless device 104 and the station device 102. Further, the data 208 may store synchronization signal in the data packet to synchronize internal clocks of the wireless device 104 with the station device 102. The synchronization signal may be used as reference point for exact receiving time of the ultrasound audio signal by the wireless device 104.

Memory 202 includes TOF detector 210 that may be configured to calculate physical distance between the wireless device 104 and the station device 102. For example, the TOF detector 210 may receive the ultrasound audio signal through a microphone component 212 at a particular instance (e.g., time “t₁”). In this example, the TOF detector 210 may be configured to retrieve transmission time (e.g., time “t₂”) of the received ultrasound audio signal stored at the data 208. The TOF detector 210 may calculate the TOF by determining time difference between the receiving time “t₁” and the transmission time “t₂” of the ultrasound audio signal. Accordingly, the TOF detector 210 may calculate the physical distance between the wireless device 104 and the station device 102 by multiplying the TOF with speed of light (i.e., 299,792.458 meters per second).

In an implementation, the wireless device 104 may include a radio 214. The radio 214 may include the microphone 212, a transmitter 216 that is coupled to an antenna 218, and a speaker 220. In an implementation, the antenna 212 may be used to establish wireless connection with the station device 102. For example, the antenna 216 may receive the WiFi signal that is transmitted using the standard IEEE 802.11a frequency band (e.g., 5 GHz). In other implementations, a light signal may be used to establish wireless connection between the wireless device 104 and the station device 102. The speaker 220 may be used to generate the ultrasound audio signal when the wireless device 104 acts a server station such as, the station device 102. The ultrasound audio signal may include audio signals that are not audible to humans (e.g., 20 KHz). It is to be understood that the wireless device 104 may include other communication interfaces (not shown), other than the radio 214.

The example wireless device 104 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

### Example Wireless Device Locations

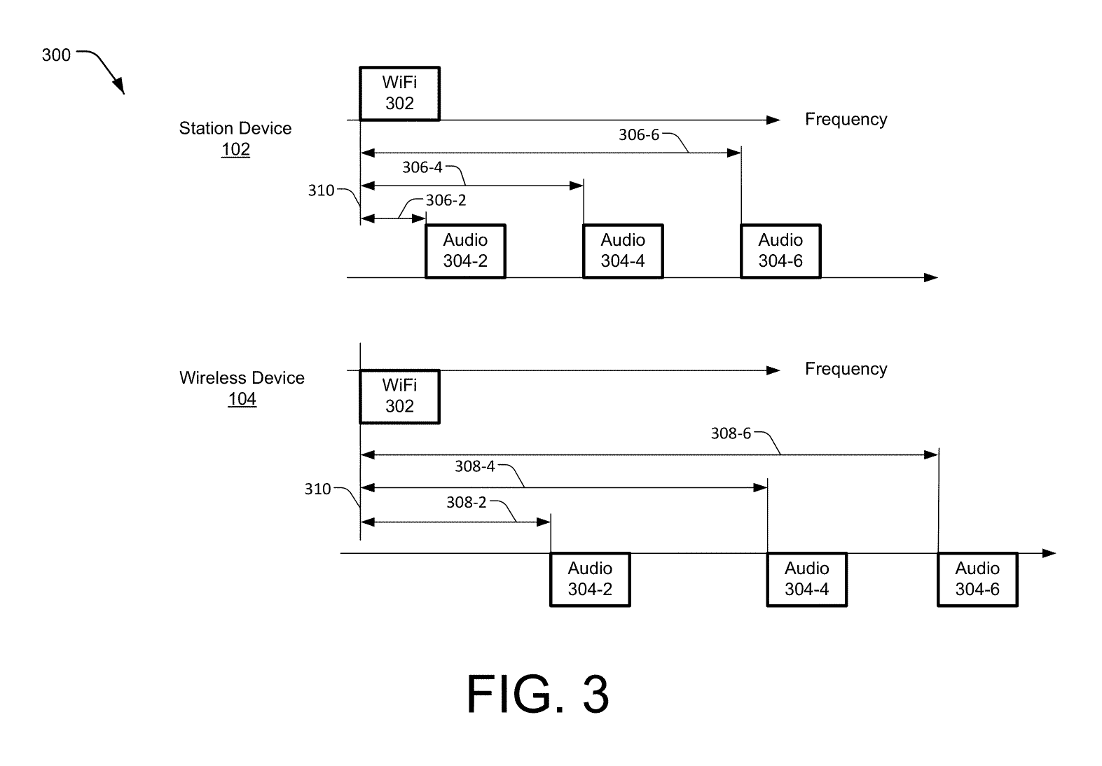

FIG. 3 is a diagram 300 illustrating an example transmission and reception of ultrasound audio signal to implement presence sensor. In an implementation, the station device 102 may establish wireless connection with the wireless device 104 through WiFi signal 302. As discussed above, the WiFi signal 302 may use the IEEE 802.11 standard such as, the use of 5 GHz frequency for the IEEE 802.11.a standard. The WiFi signal 302 may be received at the wireless device 104 within a negligible amount of time. In other words, the TOF for the WiFi signal 302 may be ignored with negligible error. In an implementation, the WiFi signal 302 may include the data packet that contains transmitting time information such as, time 306-2 when generating first audio 304-2, time 306-4 when generating second audio 304-4, and time 306-6 when generating third audio 304-6. The transmission time frequency of the audio signal 304 may be received and stored by the wireless device 104. The audio signal 304 may include an ultrasound audio signal frequency that may be generated by a speaker component (not shown) at the station device 102.

In an implementation, the wireless device 104 may receive the audio 304-2 at receiving time 308-2, the audio 304-4 at receiving time 308-4, and the audio 304-6 at receiving time 308-6. The wireless device 104 may compute the TOF for audio 304-2 by subtracting transmitting time 306-2 from receiving time 308-2. The wireless device 104 may determine the actual distance by multiplying the TOF with the speed of light. Depending upon time delay in the receiving times 308-4 and 308-6 for the audio 304-4 and audio 304-6 respectively, the wireless device 104 may have different actual distances from the station device 102. In an implementation, synchronization time 310 may include the reference point for measuring the receiving time 308 and the transmitting time 306. The synchronization time 310 may be derived from the synchronization signal contained in the data packet when the wireless connection is established between the station device 102 and the wireless device 104.

### Example Process

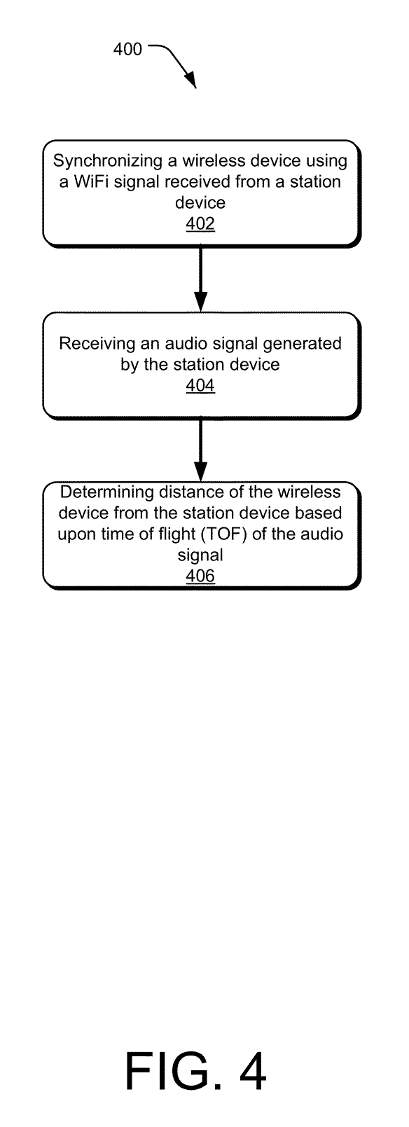

FIG. 4 shows an example process chart illustrating an example method for presence sensor using ultrasound audio signal. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention. For example, at least one computer accessible medium may perform the method described below.

At block 402, synchronizing a wireless device is performed. In an implementation, the wireless device (e.g., wireless device 104) may receive a WiFi signal to establish wireless connection with another device such as, station device 102. The WiFi signal may include a data packet that includes a synchronization signal to synchronize an internal clock of the wireless device 104 with the station device 102. The data packet may further include transmitting time information for generation of ultrasound audio signal from the station device 102. The transmitting time information may be stored at the wireless device 104.

At block 404, receiving of the ultrasound audio signal by the synchronized wireless device is performed. In an implementation, the wireless device 104 may include a microphone component (e.g., microphone component 212) to receive the ultrasound audio signal. Further, the receiving time of the ultrasound audio signal may be determined and stored by the wireless device 104.

At block 406, determining distance of the wireless device from the station device based upon TOF of the received ultrasound audio signal is performed. In an implementation, the wireless device 104 may be configured to compute the TOF by subtracting the stored receiving time (e.g., receiving time 308-2) from the stored transmitting time (e.g., transmitting time 306-2) for a particular audio signal (e.g., audio 304-2). Furthermore, the wireless device 104 may multiply the calculated TOF with speed of light in order to determine actual distance of the wireless device 104 from the station device 102. In other implementations, multiple station devices 102 may be used to determine bearing location and actual distance of the wireless device 104 from the station device 102 (i.e., similar to global positioning system (GPS) application).

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. A method of presence sensor comprising:
synchronizing a wireless device using a WiFi signal from a station device, the WiFi signal includes a data packet containing transmitting time information for an ultrasound audio signal generated by the station device;
receiving of the ultrasound audio signal by the synchronized wireless device; and
determining distance of the synchronized wireless device from the station device based upon a time of flight (TOF) of the ultrasound audio signal, the TOF includes difference between receiving time and the transmitting time of the ultrasound audio signal.

2. The method of claim 1, wherein the synchronizing includes synchronization of internal clocks of the wireless device with the station device.

3. The method of claim 1, wherein the synchronizing includes the WiFi signal that is transmitted using standard frequency defined under Institute of Electrical and Electronics Engineers (IEEE) 802.11a.

4. The method of claim 1, wherein the ultrasound audio signal includes 20 KHz frequency that is generated by a speaker component of the station device.

5. The method of claim 1, wherein the ultrasound audio signal is received by a microphone component of the wireless device.

6. The method of claim 1, wherein the determining includes multiple station devices to determine bearing location and the distance of the wireless device from the station device.

7. The method of claim 1 further comprising multiplying the TOF with speed of light to obtain actual distance between the wireless device and the station device.

8. A wireless device comprising:
one or more processors;
memory configured to the one or more processors that comprises:
a data component that stores a WiFi signal data packet that includes a synchronization signal and transmitting time information for an audio signal generated by a station device;
a time of flight (TOF) detector that measures distance of the wireless device from the station device based upon a time of flight (TOF) of the audio signal, the TOF includes difference between receiving time and the transmitting time of the audio signal;
an antenna that receives the WiFi signal; and
a microphone that receives the audio signal from the station device.

9. The wireless device of claim 8, wherein the data component stores the synchronization signal that synchronizes internal clocks of the wireless device with the station device.

10. The wireless device of claim 8, wherein the TOF detector multiplies the TOF with speed of light to obtain actual distance.

11. The wireless device of claim 8, wherein the TOF detector measures the receiving time after synchronization of wireless device internal clocks with the station device.

12. The wireless device of claim 8, wherein the antenna receives the WiFi signal that is transmitted using standard frequency defined under Institute of Electrical and Electronics Engineers (IEEE) 802.11a.

13. The wireless device of claim 8, wherein the microphone receives the audio signal that includes an ultrasound frequency audio signal generated by a speaker component of the station device.

14. At least one computer accessible medium that performs method of presence sensor comprising:
synchronizing a wireless device using a WiFi signal from a station device, the WiFi signal includes a data packet containing transmitting time information for an ultrasound audio signal generated by the station device;
receiving of the ultrasound audio signal by the synchronized wireless device; and
determining distance of the synchronized wireless device from the station device based upon a time of flight (TOF) of the ultrasound audio signal, the TOF includes difference between receiving time and the transmitting time of the ultrasound audio signal.

15. The computer accessible medium of claim 14, wherein the synchronizing includes synchronization of internal clocks of the wireless device with the station device.

16. The computer accessible medium of claim 14, wherein the synchronizing includes the WiFi signal that is transmitted using standard frequency defined under Institute of Electrical and Electronics Engineers (IEEE) 802.11a.

17. The computer accessible medium of claim 14, wherein the ultrasound audio signal is generated by a speaker component of the station device.

18. The computer accessible medium of claim 17, wherein the ultrasound audio signal is received by a microphone component of the wireless device.

19. The computer accessible medium of claim 14, wherein the determining includes multiple station devices to determine bearing location and the distance of the wireless device from the station device.

20. The computer accessible medium of claim 14 further comprising multiplying the TOF with speed of light.
